(19) United States
(12) Patent Application Publication
(10) Pub. No.: US 2006/0185537 A1
(43) Pub. Date: Aug. 24, 2006

(54) Method for positioning a sleeve on a printing-press cylinder, and printing-press cylinder

(75) Inventors: Eduard Hoffmann, Bobingen (DE); Christian Sameit, Augsburg (DE); Lorenz Stotz, Stadtbergen (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/357,586

(22) Filed: Feb. 17, 2006

(30) Foreign Application Priority Data
Feb. 18, 2005 (DE) 10 2005 007 417.0

(51) Int. Cl. B41F 5/00

(52) U.S. Cl. 101/216

(57) ABSTRACT

A method for positioning a sleeve on a printing-press cylinder includes providing a printing-press cylinder, a sleeve which is to be positioned on the printing-press cylinder, and a polyvinyl alcohol. The polyvinyl alcohol is applied to at least one of an outer surface of the printing-press cylinder and an inner surface of the sleeve. The sleeve is then pushed or pulled onto the printing-press cylinder such that the outer surface of the printing-press cylinder and the inner surface of the sleeve lie confrontingly opposed to one another.

### BACKGROUND OF THE INVENTION

The present invention relates to a method for positioning a sleeve on a printing-press cylinder. Furthermore, the present invention also relates to a printing-press cylinder.

Sleeves promote the smooth and jolt-free rolling of printing-press cylinders on one another as a consequence of the absence of interruption by clamping channels on the circumference of the cylinders which are otherwise present. In a procedure according to the prior for positioning a sleeve on a printing-press cylinder, a film is first positioned on the printing-press cylinder and the sleeve is subsequently pushed or pulled onto the printing-press cylinder or onto the film which is positioned on the latter. The film which is positioned between the printing-press cylinder and the sleeve in the prior art prevents an undesired relative movement between the sleeve and the printing-press cylinder during operation of the printing press. However, mounting a film of this type on the printing-press cylinder is associated with a great expenditure on time. Moreover, the film is damaged very easily while a sleeve is being pulled onto and off from the printing-press cylinder. Damage can also be caused to the sleeve here. Accordingly, there are many disadvantages associated with positioning the film between the printing-press cylinder and the sleeve during positioning of the sleeve on the printing-press.

### SUMMARY OF THE INVENTION

An object of the present invention is to provide a method for positioning a sleeve on a printing-press cylinder which overcomes the problems associated with the prior art.

The object is met by a method for positioning a sleeve on a printing-press cylinder which includes the steps of providing a printing-press cylinder, providing a sleeve which is to be positioned on the printing-press cylinder, and providing a polyvinyl alcohol, wherein the polyvinyl alcohol is applied to at least one of an outer surface of the printing-press cylinder and an inner surface of the sleeve. Subsequent to the application of the polyvinyl alcohol, the sleeve is pushed or pulled onto the printing-press cylinder to a relative position in which the outer surface of the printing-press cylinder and the inner surface of the sleeve lie confrontingly opposed to one another with the polyvinyl alcohol arranged therebetween.

The method according to the present invention allows simple, rapid and reliable positioning of a sleeve on a printing-press cylinder. The requirement for a film according to the prior art is obviated by the method according to the present invention. The relative position between the sleeve and the printing-press cylinder is secured by the polyvinyl alcohol which is applied to the one of the printing-press cylinder and the sleeve.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

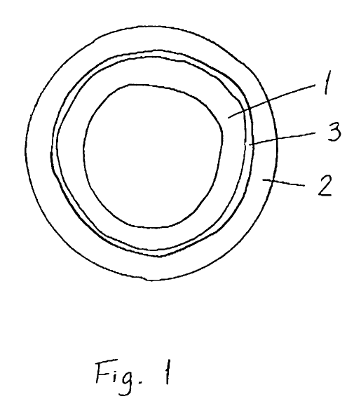

The drawing FIG. 1 is a cross-sectional view of a printing-press cylinder with a sleeve assembled according to an embodiment of the present invention.

### DETAILED DESCRIPTION OF THE PRESENTLY PREFERRED EMBODIMENTS

With reference to the sole Figure of the application, the procedure for positioning a sleeve on a printing-press cylinder is as follows. A printing-press cylinder 1 is first provided along with a sleeve 2 which is to be positioned on the printing-press cylinder. A polyvinyl alcohol is also provided The polyvinyl alcohol is preferably an anti-corrosion agent based on isopropanol or on isopropyl alcohol such as, for example, the polyvinyl alcohol which is marketed by the company OKS under the commercial name omniCOR 300.

The polyvinyl alcohol is applied to an outer surface of the printing-press cylinder and/or to an inner surface of the sleeve. During the application of the polyvinyl alcohol, at least part of the isopropanol evaporates. The remaining parts of the polyvinyl alcohol form a coating 3 on the printing-press cylinder 1 and/or sleeve 2. The polyvinyl alcohol is applied to the outer surface of the printing-press cylinder 1 and/or the inner surface of the sleeve 2 in such a way that gap-free wetting takes place over the full area of the respective surface such that a gap-free coating 3 is formed thereon after the evaporation of the isopropanol. The coating 3 is formed on the respective surface in an overall thickness of at most 10 μm. The sleeve 2 is subsequently pushed or pulled onto the printing-press cylinder 1 such that the outer surface of the printing-press cylinder 1 and the inner surface of the sleeve 2 lie confrontingly opposed to one another with the coating 3 which was provided by the application of the polyvinyl alcohol positioned between them.

The outer surface of the printing-press cylinder 1 and/or to the inner surface of the sleeve 2 on which the polyvinyl alcohol is to be applied can be cleaned or degreased and roughened before application of the polyvinyl alcohol thereto. Roughening can be carried out, for example, by sandblasting the respective surface. The polyvinyl alcohol is preferably applied exclusively to the outer surface of the printing-press cylinder. As an alternative, the polyvinyl alcohol can also be applied exclusively to the inner surface of the sleeve. Furthermore, it is possible to apply the polyvinyl alcohol to the outer surface of the printing-press cylinder and the inner surface of the sleeve.

It is possible to position a sleeve simply and rapidly on a printing-press cylinder using the method according to the present invention, while also securing of the relative position between the sleeve and the printing-press cylinder. Films between the printing-press cylinder and the sleeve which are required according to the prior art can be dispensed with as a result of the present invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for positioning a sleeve on a printing-press cylinder, comprising the steps of:
providing a printing-press cylinder, a sleeve which is to be positioned on the printing-press cylinder, and a polyvinyl alcohol;
applying the polyvinyl alcohol as a coating on at least one of an outer surface of the printing-press cylinder and an inner surface of the sleeve;
pushing or pulling the sleeve onto the printing-press cylinder such that the outer surface of the printing-press cylinder and the inner surface of the sleeve lie confrontingly opposed one another after said step of pushing and pulling with the coating arranged therebetween.

2. The method of claim 1, wherein said step of applying the polyvinyl alcohol comprises wetting the entire surface of the at least one of the outer surface of the printing-press cylinder and/or the inner surface of the sleeve with the polyvinyl alcohol without gaps.

3. The method of claim 1, wherein said step of applying the polyvinyl alcohol includes applying the polyvinyl alcohol to the at least one of the outer surface of the printing-press cylinder and the inner surface of the sleeve in an overall thickness less than or equal to 10 μm.

4. The method of claim 1, further comprising the step of cleaning the at least one of the outer surface of the printing-press cylinder and the inner surface of the sleeve before said step of applying of the polyvinyl alcohol.

5. The method of claims 4, further comprising the step of roughing the at least one of the outer surface of the printing-press cylinder and the inner surface of the sleeve before said step of applying the polyvinyl alcohol.

6. The method of claims 1, further comprising the step of roughing the at least one of the outer surface of the printing-press cylinder and the inner surface of the sleeve before said step of applying the polyvinyl alcohol.

7. The method of claim 1, wherein the polyvinyl alcohol comprises an anti-corrosion agent based on isopropanol or isopropyl alcohol, and the isopropanol at least partially evaporates during said step of applying the polyvinyl alcohol.

8. The method of claim 1, wherein said step of applying the polyvinyl alcohol includes applying the polyvinyl alcohol exclusively to the outer surface of the printing-press cylinder.

9. A printing-press cylinder assembly of a printing press, comprising:
a printing press cylinder having an outer surface;
a sleeve having an inner surface, said sleeve positioned on said printing-press cylinder such that said outer surface of said printing-press cylinder confrontingly opposes said inner surface of said sleeve; and
a coating based on a polyvinyl alcohol arranged between said outer surface of said printing-press cylinder and said inner surface of said sleeve, said coating being applied to at least one of said outer surface of said printing-press cylinder and said inner surface of said sleeve and improving adhesion of said sleeve on said printing-press cylinder.

10. The printing-press cylinder of claim 9, wherein said coating comprises an overall thickness less than or equal to 10 μm.

11. The printing-press cylinder of claim 9, wherein said at least one of said outer surface of said printing-press cylinder and said inner surface of said sleeve is cleaned before application of said polyvinyl alcohol thereon.

12. The printing-press cylinder of claim 9, wherein said at least one of said outer surface of said printing-press cylinder and said inner surface of said sleeve is roughened.

13. The printing-press cylinder of claim 9, wherein said coating comprises an anti-corrosion agent based on isopropanol or isopropyl alcohol, wherein isopropanol is at least partially evaporated from said polyvinyl alcohol during said step of applying said polyvinyl alcohol.
